(19) United States
(12) Patent Application Publication
(10) Pub. No.: US 2026/0013026 A1
(43) Pub. Date: Jan. 8, 2026

(54) CURVED PLASMA ELECTRODE STRUCTURE AND PLASMA DEVICE FOR SKIN SURFACE TREATMENT

(71) Applicant: Stalwart Elite Technology Co., Ltd., Taipei City (TW)

(72) Inventors: FEI-WEN HUANG, Taipei (TW); CHIH-TUNG LIU, Taipei (TW); CHUN-PING HSIAO, Taipei (TW); CHUN-HAO CHANG, Taipei (TW); YU-TING LIN, Taipei (TW)

(21) Appl. No.: 18/957,178

(22) Filed: Nov. 22, 2024

(30) Foreign Application Priority Data
Jul. 8, 2024 (TW) 113125526

(51) Int. Cl. H05H 1/24

(52) U.S. Cl. CPC H05H 1/2418; H05H 1/2437; H05H 1/2441; H05H 2245/34

(57) ABSTRACT

A curved plasma electrode structure for skin surface treatment includes a curved electrode, a metal oxide dielectric layer formed on a curved surface of the curved electrode, and a buffer dielectric layer laminated to the metal oxide dielectric layer. The buffer dielectric layer has a lower dielectric strength than the metal oxide dielectric layer.

### CROSS-REFERENCE TO RELATED APPLICATION

This application claims the priority benefit of Taiwan application serial no. 113125526, filed Jul. 8, 2024. The entirety of the above-mentioned patent application is hereby incorporated by reference herein and made a part of this specification.

### BACKGROUND

### Field of the Invention

The invention relates to a curved plasma electrode structure and a plasma device for skin surface treatment.

### Description of the Related Art

Currently, the application of cold plasma generated at room temperature is common in skin beauty or treatment technologies. For example, cold plasma can accelerate wound healing or help skin recover faster after beauty treatments by stimulating skin cell regeneration and promoting blood circulation. Cold plasma also promotes cell division and metabolism, increasing skin elasticity and firmness, thus achieving anti-aging effects. It can also open the skin's pores and improve the absorption efficiency of skincare products or medications, thus further enhancing skin texture, appearance, and therapeutic effect on the skin.

However, current plasma skin treatment devices often suffer from the problem of uneven discharge intensity, leading to localized high-density currents that cause users to experience stinging or burning sensations. Additionally, these devices typically use ambient air to generate ionized gas, making it crucial to design them in a way that maintains an appropriate air gap between the plasma skin treatment device and the skin surface.

### BRIEF SUMMARY OF THE INVENTION

In order to achieve one or a portion of or all of the objects or other objects, one embodiment of the invention provides a curved plasma electrode structure for skin surface treatment including a curved electrode, a metal oxide dielectric layer formed on a curved surface of the curved electrode, and a buffer dielectric layer laminated to the metal oxide dielectric layer. The buffer dielectric layer has a lower dielectric strength than the metal oxide dielectric layer.

Another embodiment of the invention provides a plasma device for skin surface treatment including a power circuit, a transformer circuit and a plasma electrode structure. The transformer circuit is configured to convert an output signal of the power circuit into a high-voltage signal, and the rise time of the high-voltage signal is less than 1500 nanoseconds. The plasma electrode structure is configured to receive the high-voltage signal to ionize gas and generate plasma acting on a skin surface. The plasma electrode structure includes a curved electrode, a first dielectric layer formed on a curved surface of the curved electrode, and a second dielectric layer laminated to the first dielectric layer. The second dielectric layer is made of a different material from the first dielectric layer and has a lower dielectric constant than the first dielectric layer.

Through the design of the above embodiments, by using the buffer dielectric layer with a lower dielectric strength than the metal oxide dielectric layer, the discharge intensity and uniformity can be adjusted to prevent localized high current density, thus ensuring that the user does not experience discomfort or burning sensations on the skin. Additionally, the inclusion of a third dielectric layer further adjusts the current intensity and uniformity, ensuring more stable and uniform plasma discharge to allow the user not to experience any discomfort on the skin. Moreover, the curved contour of the electrode is designed to closely conform to the skin's surface, which helps maintain an appropriate distance from the curved skin surface to generate uniformly distributed plasma that evenly targets the desired area. Furthermore, the naturally raised sides of the curved profile can create the necessary air space relative to the skin surface, thus facilitating the generation of plasma. Besides, forming the metal oxide dielectric layer by directly oxidizing the metal surface of the discharge electrode may reduce material costs and simplify manufacturing processes of the dielectric layer.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a plasma device for skin surface treatment according to an embodiment of the invention.

FIG. 2 shows a schematic diagram of a curved plasma electrode structure according to an embodiment of the invention.

FIG. 3 shows a schematic diagram of a plasma device for skin surface treatment according to another embodiment of the invention.

FIG. 4 presents a comparison using actual test photos and schematic diagrams to illustrate different plasma discharge performances tested under different high-voltage signals with varying rise times.

FIG. 5 presents a comparison using actual test photos and schematic diagrams to illustrate different plasma discharge performances tested under three different thicknesses of the metal oxide dielectric layer.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc, as used herein, are used as labels for nouns that they precede, and do not imply any type of ordering (e.g., spatial, temporal, logical, etc.).

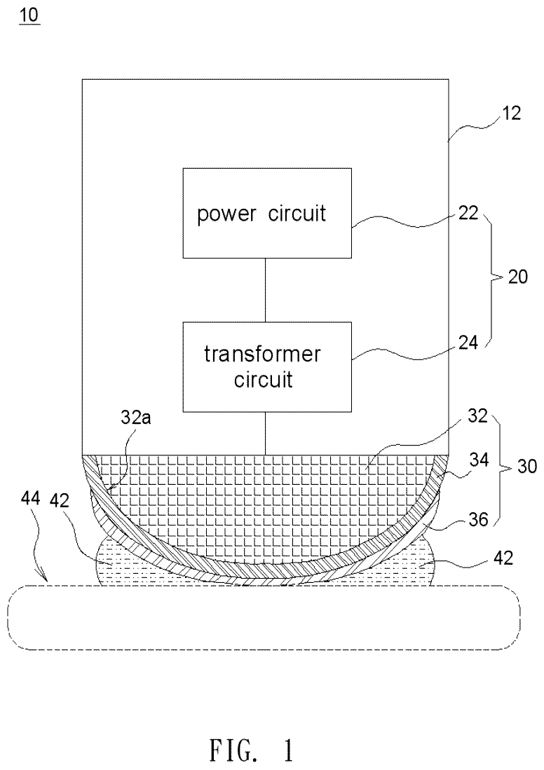

FIG. 1 shows a schematic diagram of a plasma device for skin surface treatment according to an embodiment of the invention. As shown in FIG. 1, a plasma device 10 includes a drive unit 20 and a curved plasma electrode structure 30 disposed within a housing 12. In this embodiment, the drive unit 20 includes a power circuit 22 and a transformer circuit 24. The power circuit 22 may include a DC voltage source, such as a battery, and a high-frequency oscillator to generate a low-voltage high-frequency signal. The transformer circuit 24 can boost the low-voltage high-frequency signal from the power circuit 22 to the required high voltage level, converting it into a high-voltage signal. When the high-voltage signal is transmitted to the plasma electrode structure 30, it can ionize the gas to generate plasma 42. The plasma 42 can act on the skin surface 44 for various cosmetic or therapeutic treatments.

In this embodiment, the curved plasma electrode structure 30 includes at least one curved electrode 32, a metal oxide dielectric layer 34, and a buffer dielectric layer 36. As used herein, the term “curved electrode” means the surface (such as the surface 32a shown in FIG. 1) of a discharge electrode facing the skin surface 44 has a curved shape, and the curved shape may be spherical, cylindrical, conical, parabolic, hyperbolic, saddle-shaped, or a combination of these geometrical forms. As shown in FIG. 1, the metal oxide dielectric layer 34 is formed on the curved surface 32a of the curved electrode 32, and the buffer dielectric layer 36 is laminated to the metal oxide dielectric layer 34 and is disposed between the metal oxide dielectric layer 34 and the skin surface 44. In this embodiment, the curved electrode 32 may be made of metal, and the metal oxide dielectric layer 34 may be directly formed by oxidizing the metal surface of the curved electrode 32. For example, the curved electrode 32 can be made of aluminum, magnesium, titanium, or their alloys, and the metal surface of the curved electrode 32 can be oxidized to form aluminum oxide, magnesium oxide, or titanium oxide that constitutes the metal oxide dielectric layer 34. Moreover, metal oxides such as the aluminum oxide, magnesium oxide, or titanium oxide may have relatively high dielectric constants (e.g., ranging from 7.5 to 15) and dielectric strengths (e.g., ranging from 10 to 300 kV/mm), providing resistance to high temperatures and preventing arc breakdown. The buffer dielectric layer 36 offers enhanced protection for the skin surface 44 and can regulate the discharge intensity and uniformity, thus preventing localized high current density and ensuring that the user does not experience discomfort or burning sensations due to high-temperature current surges. In this embodiment, the buffer dielectric layer 36 is made of a different material than the metal oxide dielectric layer 34, and can be made of materials with relatively low dielectric constants and dielectric strengths as compared with the metal oxide dielectric layer 34, such as Teflon, plastic, silicone, or a composite material containing at least one of Teflon, plastic and silicone. In one embodiment, a dielectric constant of the buffer dielectric layer 36 may range from 1 to 5, a dielectric strength of the buffer dielectric layer 36 may range from 10 to 60 kV/mm, and a thickness of the buffer dielectric layer 36 may range from 10 to 200 μm. Furthermore, when the curvature is too sharp, it is prone to cause high-temperature current surges. Therefore, in one embodiment, the radius of curvature of the curved electrode 32 is preferably greater than 0.3 mm. As shown in FIG. 1, the curved profile of the curved electrode 32 can better conform to the curved skin surface (e.g., the sides of the nose) and help maintain an appropriate distance from the curved skin surface to generate uniformly distributed plasma, thus acting uniformly on the target area of the skin. Moreover, the upwardly curving sides of the curved profile may naturally create air chambers relative to the skin surface 44 to facilitate the generation of plasma 42.

In one embodiment, a thickness of the metal oxide dielectric layer 34 may range from 5 to 150 μm, and more preferably from 50 to 150 μm to further ensure the prevention of arc breakdown.

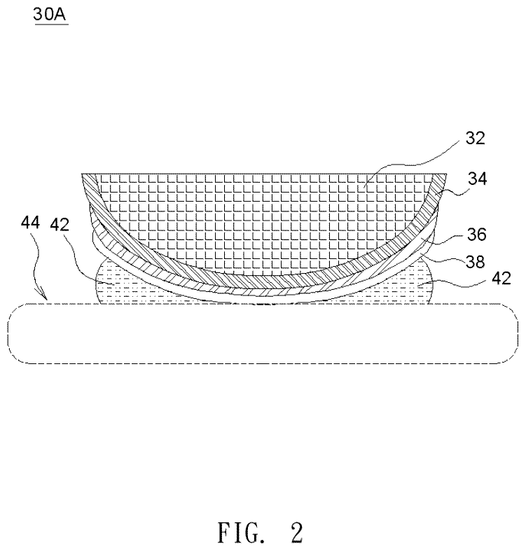

According to various embodiments of the invention, the plasma electrode structure may include multiple dielectric layers made of different materials, and the number of dielectric layers is not limited. FIG. 2 shows a schematic diagram of a curved plasma electrode structure according to another embodiment of the invention. As shown in FIG. 2, the curved plasma electrode structure 30A includes not only the metal oxide dielectric layer 34 and the buffer dielectric layer 36 but also a third dielectric layer 38 made of a different material from the metal oxide dielectric layer 34 and the buffer dielectric layer 36. The dielectric layer 38 is disposed on one side of the buffer dielectric layer 36 facing the skin surface 44. The provision of the dielectric layer 38 can further adjust the current intensity and uniformity, ensuring that the user's skin does not experience any discomfort. The material of the dielectric layer 38 can be selected as needed to provide additional effects. For example, the dielectric layer 38 can be made of a polymer resin material to provide both aesthetic and protective functions.

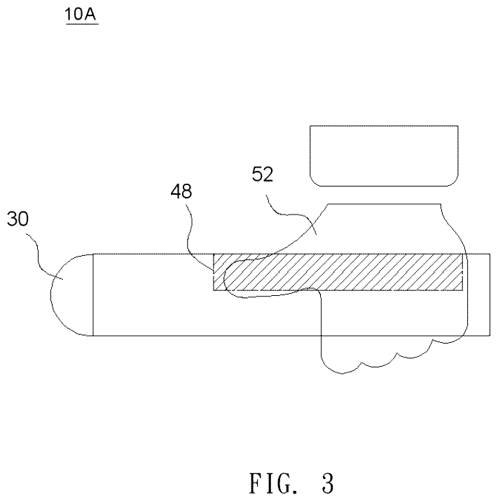

FIG. 3 shows a plasma device for skin surface treatment according to another embodiment of the invention. As shown in FIG. 3, the plasma device 10A can be configured as a handheld device, with a grounding electrode 48 provided at a position corresponding to the user's hand 52. When the user uses the plasma device 10A to treat the skin and the hand 52 contacts the grounding electrode 48, the plasma device 10A forms a discharge loop with the hand 52 to effectively control the discharge state of the plasma.

Generally, the shorter the rise time of the drive waveform used to generate plasma, the more it can avoid excessive current during plasma discharge. Herein, the term “rise time” is defined as the time required for the signal to rise from a low level (10% level) to a high level (90% level). Table 1 below outlines plasma discharge performances in actual tests using the same plasma electrode structure 30 (with a metal oxide dielectric layer 34 and a buffer dielectric layer 36) under three different high-voltage signals with varying rise times.

TABLE 1

| Rise time | Plasma discharge performance |
|---|---|
| More than 10 microseconds | Poor (generating electric arcs; |
| | uneven plasma discharge) |
| About 3.7 microseconds | Poor (generating electric arcs; |
| | uneven plasma discharge) |
| About 70 nanoseconds | Good (no electric arcs; |
| | even plasma discharge) |

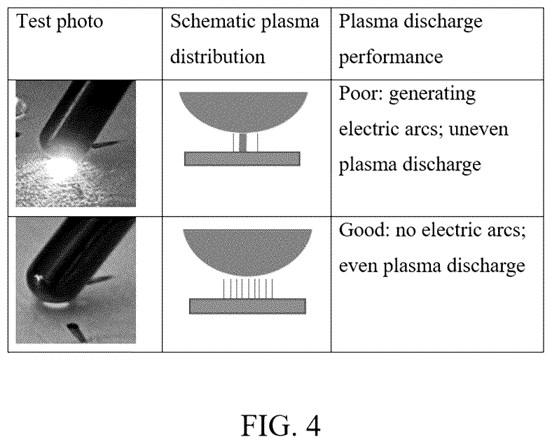

FIG. 4 presents a comparison using actual test photos and schematic diagrams to illustrate the ‘Poor discharge performance’ and ‘Good discharge performance’ as outlined in Table 1. The schematic diagrams use line thickness and position to visually represent plasma intensity distribution corresponding to the test photos. As shown in Table 1 and illustrated in FIG. 4, under a longer rise time (greater than 10 microseconds or approximately 3.7 microseconds), high-temperature arcs are produced (indicating a poor discharge performance). Conversely, under a shorter rise time (approximately 70 nanoseconds), no high-temperature arcs are produced, and plasma can be generated uniformly (indicating a good discharge performance). This is because, under a longer rise time, ion reactions within the plasma become more significant, allowing sufficient time for gas heating and even producing streamer discharge effects. This may damage the plasma electrode and lead to the formation of high-temperature arcs, which is particularly unfavorable for applications on thermally sensitive materials, such as the skin surface. Therefore, in at least some embodiments of the invention, when generating low-temperature plasma for use on thermally sensitive materials, it is preferable for the rise time of the high-voltage signal used to ionize the gas to be less than 1500 nanoseconds.

Table 2 below outlines plasma discharge performances in actual tests for different plasma electrode structures: one with only a metal oxide dielectric layer 34, one with a combination of a metal oxide dielectric layer 34 and a buffer dielectric layer 36, and one with a metal oxide dielectric layer 34 combined with both a buffer dielectric layer 36 and a third dielectric layer 38. These performances are also evaluated under three different thicknesses (25 um, 65 um and 100 um) of the metal oxide dielectric layer 34.

TABLE 2

| | | Combination of | Combination of |
|---|---|---|---|
| | | layer 34 and | layer 34 layer |
| | Only layer 34 | layer 36 | 36 and layer 38 |
| Thickness of | Poor discharge | Poor discharge | Good discharge |
| layer 34: | performance | performance | performance |
| 25 um | | | |
| Thickness of | Poor discharge | Poor discharge | Good discharge |
| layer 34: | performance | performance | performance |
| 65 um | | | |
| Thickness of | Poor discharge | Good discharge | Good discharge |
| layer 34: | performance | performance | performance |
| 100 um | | | |

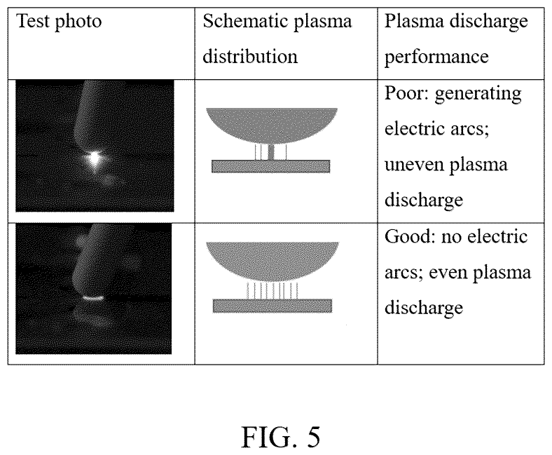

FIG. 5 presents a comparison using actual test photos and schematic diagrams to highlight the ‘Poor discharge performance’ and ‘Good discharge performance’ as outlined in Table 2. The schematic diagrams use line thickness and position to visually represent plasma intensity distribution corresponding to the test photos. As shown in Table 2 and illustrated in FIG. 5, the test results indicate that although the metal oxide dielectric layer material has better dielectric strength, under the three different test thicknesses, high-temperature arc discharge (poor discharge performance) all occurs when the plasma electrode structure only provided with the metal oxide dielectric layer 34. When a buffer dielectric layer is added to the metal oxide dielectric layer having a thickness of 100 μm, uniform plasma discharge (good discharge performance) can be achieved. This is because the buffer dielectric layer 36 may help reduce excessive charge accumulation, which is a consequence of the high dielectric constant of the metal oxide dielectric layer 34. Such excessive charge accumulation could otherwise lead to non-uniform discharge or even arc discharge. Moreover, when using the metal oxide dielectric layer 34, the buffer dielectric layer 36, and the third dielectric layer 38 together, stable and uniform plasma discharge (good discharge performance) can be achieved across all tested thicknesses (100 μm, 65 μm, 25 μm), making it particularly suitable for applications on sensitive materials, such as the skin surface.

Through the design of the above embodiments, by using the buffer dielectric layer with a lower dielectric strength than the metal oxide dielectric layer, the discharge intensity and uniformity can be adjusted to prevent localized high current density, thus ensuring that the user does not experience discomfort or burning sensations on the skin. Additionally, the inclusion of a third dielectric layer further adjusts the current intensity and uniformity, ensuring more stable and uniform plasma discharge to allow the user not to experience any discomfort on the skin. Moreover, the curved contour of the electrode is designed to closely conform to the skin's surface, which helps maintain an appropriate distance from the curved skin surface to generate uniformly distributed plasma that evenly targets the desired area. Furthermore, the naturally raised sides of the curved profile can create the necessary air space relative to the skin surface, thus facilitating the generation of plasma. Besides, forming the metal oxide dielectric layer by directly oxidizing the metal surface of the discharge electrode may reduce material costs and simplify manufacturing processes of the dielectric layer.

Though the embodiments of the invention have been presented for purposes of illustration and description, they are not intended to be exhaustive or to limit the invention. Accordingly, many modifications and variations without departing from the spirit of the invention or essential characteristics thereof will be apparent to practitioners skilled in this art. It is intended that the scope of the invention be defined by the claims appended hereto and their equivalents in which all terms are meant in their broadest reasonable sense unless otherwise indicated.

What is claimed is:

1. A curved plasma electrode structure for skin surface treatment, comprising:
a curved electrode;
a metal oxide dielectric layer formed on a curve surface of the curved electrode; and
a buffer dielectric layer laminated to the metal oxide dielectric layer, wherein the buffer dielectric layer has a lower dielectric strength than the metal oxide dielectric layer.

2. The curved plasma electrode structure as claimed in claim 1, wherein the metal oxide dielectric layer has a dielectric constant ranging from 7.5 to 15 and a dielectric strength ranging from 10 to 300 kV/mm.

3. The curved plasma electrode structure as claimed in claim 1, wherein the buffer dielectric layer has a dielectric constant ranging from 1 to 5 and a dielectric strength ranging from 10 to 60 kV/mm.

4. The curved plasma electrode structure as claimed in claim 1, wherein a radius of curvature of the curved electrode is greater than 0.3 mm.

5. The curved plasma electrode structure as claimed in claim 1, wherein the curved electrode is made from aluminum, magnesium or titanium.

6. The curved plasma electrode structure as claimed in claim 1, wherein the curved electrode is a metal electrode, and the metal oxide dielectric layer is an oxide layer formed on a metal surface of the curved electrode.

7. The curved plasma electrode structure as claimed in claim 1, wherein the buffer dielectric layer is disposed outside the metal oxide dielectric layer to separate the metal oxide dielectric layer from a skin surface in treatment, and the buffer dielectric layer is made of Teflon, plastic, silicone, or a composite material containing at least one of Teflon, plastic and silicone.

8. The curved plasma electrode structure as claimed in claim 1, further comprising:
a dielectric layer disposed on the buffer dielectric layer, wherein a material of the dielectric layer differs from the metal oxide dielectric layer and the buffer dielectric layer.

9. The curved plasma electrode structure as claimed in claim 1, wherein a thickness of the metal oxide dielectric layer ranges from 50 to 150 μm.

10. The curved plasma electrode structure as claimed in claim 1, wherein a thickness of the buffer dielectric layer ranges from 10 to 200 μm.

11. A plasma device for skin surface treatment, comprising:
a power circuit;
a transformer circuit configured to convert an output signal of the power circuit into a high-voltage signal, wherein the rise time of the high-voltage signal is less than 1500 nanoseconds; and
a plasma electrode structure configured to receive the high-voltage signal to ionize gas and generate plasma acting on a skin surface, wherein the plasma electrode structure comprises:
a curved electrode;
a first dielectric layer formed on a curve surface of the curved electrode; and
a second dielectric layer laminated to the first dielectric layer, the second dielectric layer being made of a different material from the first dielectric layer and having a lower dielectric constant than the first dielectric layer.

12. The plasma device as claimed in claim 11, wherein the first dielectric layer has a dielectric constant ranging from 7.5 to 15 and a dielectric strength ranging from 10 to 300 kV/mm.

13. The plasma device as claimed in claim 11, wherein the second dielectric layer has a dielectric constant ranging from 1 to 5 and a dielectric strength ranging from 10 to 60 kV/mm.

14. The plasma device as claimed in claim 11, wherein a radius of curvature of the curved electrode is greater than 0.3 mm.

15. The plasma device as claimed in claim 11, wherein the curved electrode is made from aluminum, magnesium or titanium, and the first dielectric layer is an aluminum oxide layer, a magnesium oxide layer or a titanium oxide layer formed on the curved electrode.

16. The plasma device as claimed in claim 11, wherein the second dielectric layer is made of Teflon, plastic, silicone, or a composite material containing at least one of Teflon, plastic and silicone.

17. The plasma device as claimed in claim 11, wherein a thickness of the first dielectric layer ranges from 50 to 150 μm.

18. The plasma device as claimed in claim 11, wherein a thickness of the second dielectric layer ranges from 10 to 200 μm.

19. The plasma device as claimed in claim 11, further comprising:
a third dielectric layer disposed on the second dielectric layer, wherein a material of the third dielectric layer differs from the first dielectric layer and the second dielectric layer.

20. The plasma device as claimed in claim 11, wherein the plasma device is configured as a handheld device, and the plasma device includes a grounding electrode disposed at a position corresponding to a user's hand.
